(19) United States
(12) Patent Application Publication
(10) Pub. No.: US 2017/0195421 A1
(43) Pub. Date: Jul. 6, 2017

(54) CLOUD DATA STORAGE SYSTEM AND METHOD THEREOF

(71) Applicant: WU-BEN CO., LTD., Taipei City (TW)

(72) Inventors: CHAO-WEI HSIEH, Taipei City (TW); YUNG-SUNG CHANG, Taipei City (TW)

(21) Appl. No.: 15/398,720

(22) Filed: Jan. 5, 2017

(30) Foreign Application Priority Data
Jan. 6, 2016 (TW) 105100239

(51) Int. Cl. H04L 29/08; H04L 29/06

(52) U.S. Cl. CPC H04L 67/1097; H04L 67/42; H04L 67/06; H04L 67/1095

(57) ABSTRACT

The present invention provides a cloud data storage system and the method thereof. The system according to the present invention can acquire the statuses of the data source and the client device to generate a usage status data, and the usage status data are generated according to the requirements of the current connection and the files to be accessed. The data source can actively search the usage status data and enable the connection. Then, the system determines whether to access the digital content from the data source in order to transmit the digital content to the client device. The present invention provides a system and method which will not occupy the resources of the system, and will notify the client device that the physical storage device is in connection status and usable again after the physical storage device is temporarily disconnected or shut down.

### RELATED APPLICATION

This application claims priority to Taiwan Application Serial Number 105,100,239, filed Jan. 6, 2016, which is herein incorporated by reference.

### FIELD OF THE INVENTION

The present invention relates to a cloud data storage system and method thereof, in particular to a method allowing a client device to access data from a data source via a system.

### DESCRIPTION OF THE PRIOR ART

In the current network age, the demand of accessing digital data keeps growing, no matter for an individual or a company. In order to provide more convenient services, various cloud storages with the functions similar to Dropbox or Google Drive are provided by the service providers, which gradually become the major data storage or synchronous backup space. Most of these services will not charge, and the storage spaces provided by these services can satisfy the requirements of most people. However, if a customer needs to access a large amount of data from these free cloud storages or the data of the customer is confidential, the access speed, amount of data access and security of these free cloud storages are not reliable because the physical devices of these free cloud storages are installed on the servers not owned by the customer.

For the purpose of overcoming the above shortcomings, various private cloud services are developed. A user can purchase some physical devices for personal use and install these devices in the user's home or business premise to serve as the cloud storage. However, these physical devices are of high cost; besides, if the user wants to connect to the physical devices via the system and access data from the physical devices, these physical devices should be in connection status, or the user cannot access the data from them, which will occupy a lot of resources of the system. Further, when these physical devices are temporarily disconnected or shut down, the user cannot remotely access the files from the cloud storage. Moreover, the user will not be notified that he can access the data for the cloud storage even if the physical devices are turned on and in connection status. Obviously, the aforementioned private cloud is very expensive and inconvenient, so it needs to be further improved.

### SUMMARY OF THE INVENTION

The present invention provides a cloud data storage system and the method thereof; the primary object of the present invention is to overcome the problems of the prior art, and provide a system and method which will not occupy the resources of the system, and the storage device will actively make a request to connect to the system.

Another object of the present invention is to overcome the problems of the prior art, and provide a system and method which can avoid additional cost because users do not need to purchase physical storage devices.

Another object of the present invention is to overcome the problems of the prior art, and provide a system and method which will notify the client device that the physical storage device is in connection status and accessible again after the physical storage device is temporarily disconnected or shut down.

The present invention provides a cloud data storage system, which includes a data source access unit, and the data source access unit can connect to an external data source via the network, and the data source is a device capable of storing digital content, such as computer, server and the like. The aforementioned digital content may be various different kinds of data, such as video, audio, figure, document file, system resource file or streaming data, etc.

The system according to the present invention includes a client device access unit, and the client device access unit can connect to an external client device for the client device to access the digital content from the data source via the data source access unit. The client device may be an application or interface capable of being installed on various devices (such as mobile device, computer or server), and the data source may also be an application or interface capable of being installed on various devices.

The system according to the present invention further includes an access status unit, and the access status unit connects to the data source access unit and the client device access unit. The access status unit acquires the statuses of the data source and the client device via the data source access unit and the client device access unit connecting to the access status unit (i.e. the current connection status) so as to generate a usage status data. The access status unit determines whether the data source access unit connects to the data source according to the usage status data; besides, the access status unit determines whether the client device can access the digital content from the data source via the data source access unit according to the usage status data.

The usage status data of the system according to the present invention stores a plurality of indication flags, and the aforementioned indication flags are various indicators, values or paths which stand for different system statuses and scheduled tasks. The usage status data include three flags, including a first indication flag, a second indication flag and a third indication flag. The first indication flag records the current connection status between the data source access unit and the data source (e.g. in connection status or not in connection status). The second indication flag records the digital content which the client device requests from the data source. The third indication flag records whether the access status unit should connect to the data source via the data source access unit (e.g. it is necessary to be in connection status to transmit files or it is not necessary to be in connection status if no data needs to be transmitted).

More specifically, the client device connects to the access status unit via the client device access unit. When being in connection status, the client device can request the access status unit to provide the data inventory or data list of the data source, and the access status unit can ask for the data inventory or data list from the data source via the data source access unit. The data source transmits the data inventory or data list of the data source to the client device via the data source access unit, the access status unit and the client device access unit.

Moreover, the transmission connection between the data source and the data source access unit is not always enabled; the data source actively checks the usage status data of the access status unit via the data source access unit on a periodical basis or by a predetermined time interval. If the third indication flag shows that it is necessary to enable the transmission connection and the second indication flag records the access request (e.g. requested file, data or path, etc.) transmitted from the client device to the data source after checked by the data source, the data source actively enables the transmission connection with the data source access unit; further, the data source transmits the data corresponding to the access request recorded by the second indication flag to the access status unit via the data source access unit. After the transmission connection is enabled, the data source can directly receive the access request from the client device via the access status unit, and then transmit the data. If the data source has yet to receive the access request again within a predetermined time period, the data source disables the transmission connection with the data source access unit.

When the data source transmits the data to the access status unit, the access status unit will temporarily store the data, and then transmit the data to the client device via the client device access unit. If the client device has yet to enable the transmission connection for now, the access status unit transmits a file reception notification via the client device access unit and the remote notification approach provided by the client device service provider, such as Apple Push Notification Service (APNS) provided by Apple, Google Cloud Messaging (GCM) provided by Google, Baidu Cloud Push provided by Baidu, Amazon Device Messaging (ADM) provided by Amazon or Windows Push Notification Service(WNS) provided by Microsoft, so as to notify the client device that the client device can enable the transmission connection to receive the data requested before. If the client device has yet to enable the transmission connection after a predetermined time period, the access status unit deletes the data in order to save the resources of the system and achieve high data security.

The present invention provides a cloud system for users to connect to in order to access the digital content stored in another data storage. The advantage of the system is that the users do not need to purchase the storage device corresponding to the service of the system; in other words, the users can access the files from different storage devices in connection status only by the application installed on a smart phone or a tablet computer. Besides, the system according to the present invention does not always enable the transmission connection with the storage device; the storage device will actively make a request and then enable the transmission connection if necessary, which can prevent from unnecessary resource waste. Further, when the storage device is not in connection status but the client device needs to access data therefrom, the system according to the present invention records the request and the storage device actively make a request to enable the transmission connection. The storage device transmits the data right after the storage device actively enables the transmission connection; afterward, the system according to the present invention will notify the client device that the storage device has transmitted the data to the client device; then, the client device can access the data after enabling the transmission connection. In addition, the system according to the present invention also supports the transmission resuming function after the client device or the data source is in connection status again after being disconnected. To sum up, the present invention is a file transmission system with perfect functions, of high security, capable of saving resources and without additional hardware devices.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a structure schematic view of a cloud data storage system in accordance with the present invention.

FIG. 2 is a flow chart of a cloud data storage method in accordance with the present invention for asking for a file list.

FIG. 3 is a flow chart of a cloud data storage method for a client device to ask for a file list when a data source is not in connection status.

FIG. 4 is a flow chart of a cloud data storage method for a client device to ask for a file list when a data source is in connection status.

FIG. 5 is a flow chart of a cloud data storage method for uploading files.

### DETAILED DESCRIPTION OF THE PREFERRED EMBODIMENT

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

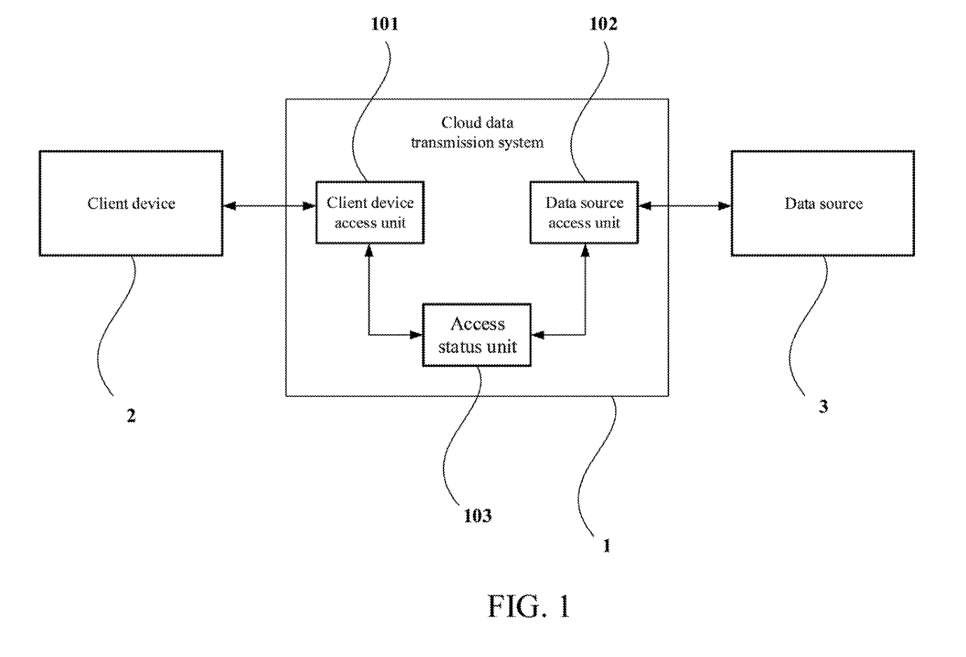

As shown in FIG. 1, the structure of a cloud data storage system is as follows: the cloud data transmission system 1 includes a client device access unit 101 and a data source access unit 102. The client device access unit 101 and the data source access unit 102 connect to each other via the access status unit 103. The client device access unit 101 can connect to an external client device via the network, and the data source access 102 can connect to an external data source via the network. The access status unit 103 can acquire the statuses of the data source 2 and the client device 3 to generate a usage status data according to the client device access unit 101 and the data source access unit 102.

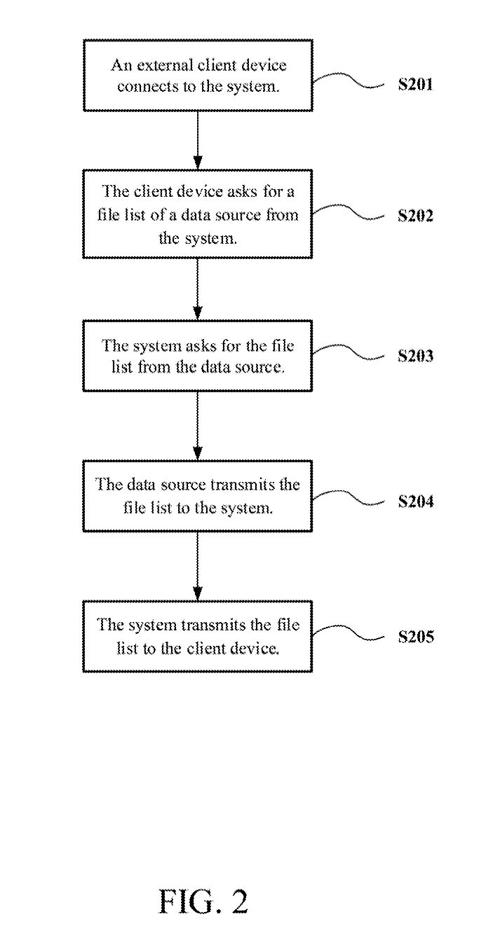

Regarding the cloud data storage method according to the present invention, the initial status step is that the client device asks for a file list from the data source via the system, and mainly includes the following steps, as shown in FIG. 2:

Step S201: an external client device connects to the system, and the system connects to the client device via a client device access unit;

Step S202: the client device asks for a file list of a data source from the system;

Step S203: an access status unit of the system asks for the file list form the data source via the data source access unit;

Step S204: the data source transmits the file list to the access status unit of the system; and

Step S205: the access status unit of the system transmits the file list to the client device. The client device also uses the same steps to update the file list from the data source via the system; the system according to the present invention only provides an approach for the data source to provide the file list for the client device, but will not store the file list in order to achieve high information security.

According to the cloud data storage method of the present invention, the client device can acquire the file list of the data source after Step S205 “the access status unit transmits the file list to the client device”.

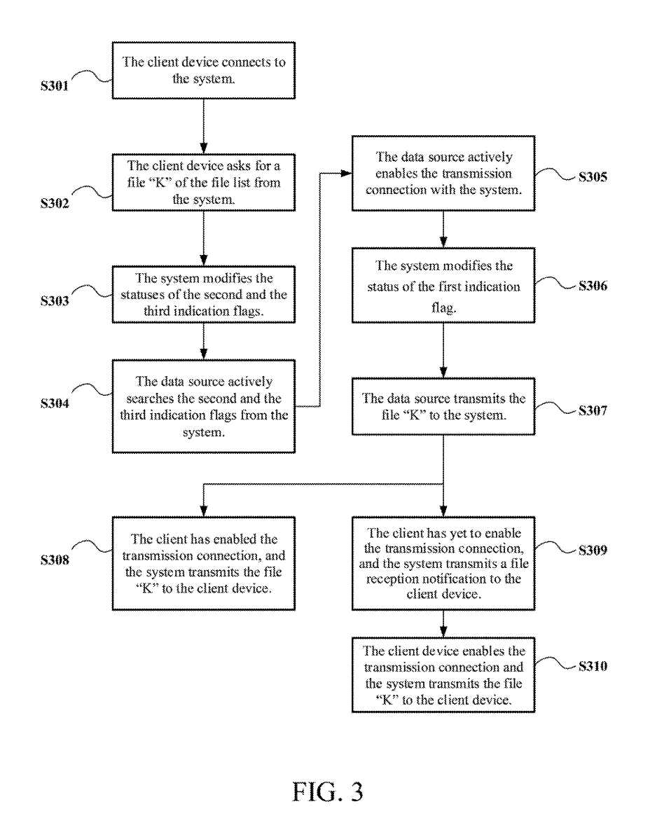

According to the present invention, the transmission connection between the data source and the system is not always enabled; in other words, the data source will check the usage status data of the access status unit of the system by a predetermined time interval so as to determine whether to temporarily enable the transmission connection. If the client device asks for a file from the data source via the system but the transmission connection of the data source has yet to be enabled, the method proceeds to the following steps, as shown in FIG. 3:

Step S301: the client device connects to the system, and the system connects the client device access unit to the client device;

Step S302: the client device asks for a file “K” of the file list from the system;

Step S303: the transmission connection between the system and the data source has yet to be enabled, so the access status unit modifies the second indication flag of the usage status data as “Need to access the file K”, and the access status unit modifies the third indication flag of the usage status data as “Need to enable the transmission connection”;

Step S304: after a period of time, the data source actively searches the third indication flag of the usage status data from the system, and then checks the second indication flag;

Step S305: the data source knows that the transmission connection should be enabled, and the data source actively enables the transmission connection with a data source access unit inside the system;

Step S306: the access status unit modifies the first indication flag of the usage status data as “In connection status”;

Step S307: the data source transmits the file “K” to the access status unit via the data source access unit of the system;

After Step S307, two conditions may take place, and the follow-up step of one of the two conditions is:

Step S308: if the client device has enabled the transmission connection, the access status unit of the system transmits the file “K” to the client device via the client device access unit.

The follow-up steps of the other of the two conditions are:

Step S309: if the client device has yet to enable the transmission connection, the access status unit of the system transmits a file reception notification to the client device via a remote notification approach; and

Step S310: the client device enables the transmission connection with the client device access unit after receiving the file reception notification; then, the access status unit of the system transmits the file “K” to the client device via the client device access unit.

Besides, after Step S307, the data source disables the transmission connection if the data source has yet to receive the access request within a predetermined time period after the data source enables the transmission connection.

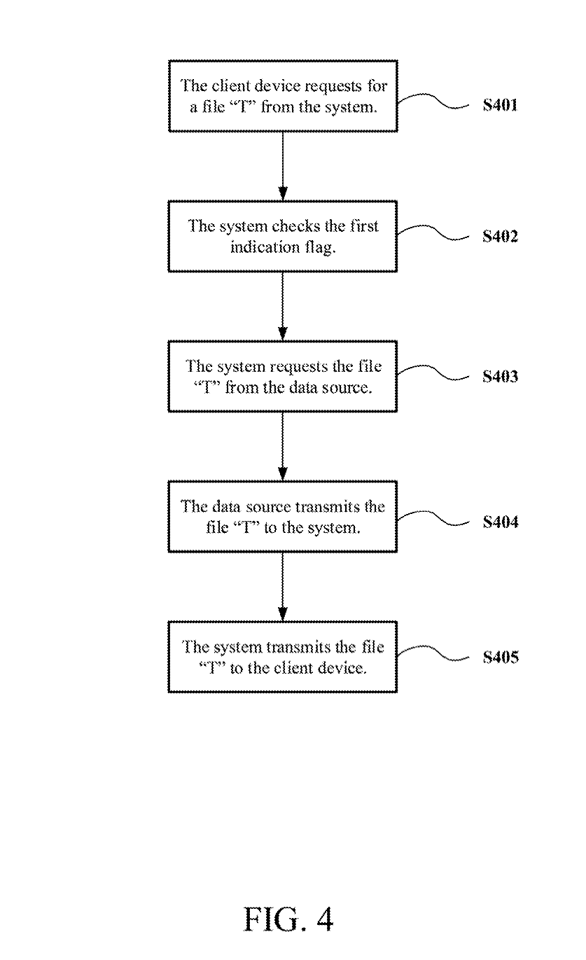

According to the cloud data storage method of the present invention, if the status of the first indication flag is “In connection status”, it means that the transmission connection between the data source and the system is enabled. When the client device asks for another file from the data source via the system, the method will proceed to the following major steps, as shown in FIG. 4:

Step S401: the client device requests for a file “T” of the file list from the system;

Step S402: the access status unit of the system checks the first indication flag, and the first indication flag shows “In connection status”;

Step S403: the access status unit of the system requests the file “T” from the data source via the data source access unit.

Step S404: the data source transmits the file “T” to the access status unit via the data source access unit of the system; and

Step S405: the access status unit of the system transmits the file “T” to the client device via the client device access unit.

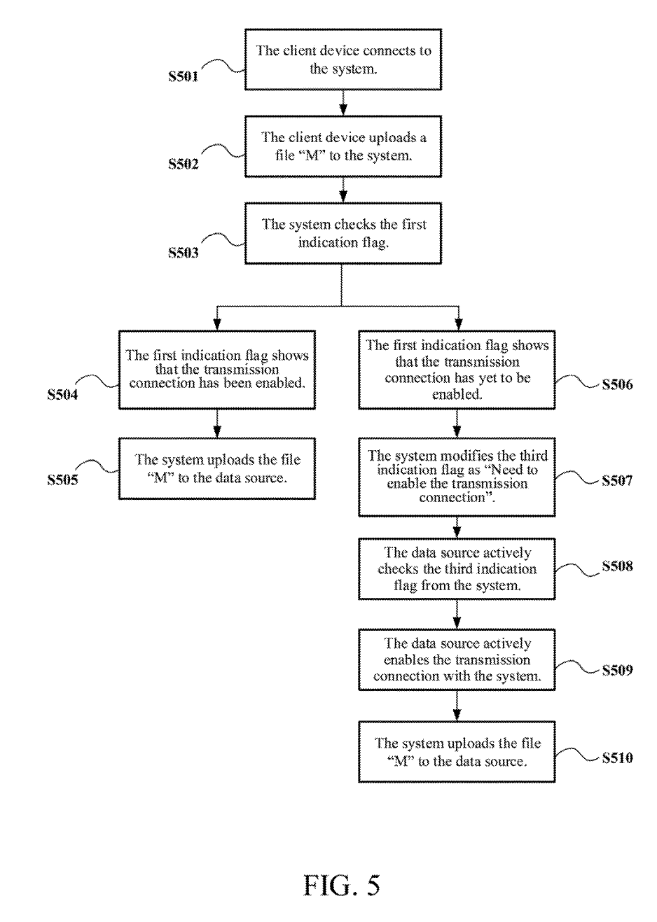

According to the cloud data storage method of the present invention, if the client device wants to upload a file to the data source via the system, the steps are as follows; please refer to FIG. 5:

Step S501: the client device connects to the system, and the access status unit of the system connects to the client device via the client device access unit;

Step S502: the client device uploads a file “M” to the access status unit of the system via the client device access unit;

Step S503: the access status unit checks the first indication flag;

Step S503 means the system is checking whether the transmission connection of the data source is enabled, so which can be classified into two conditions; the follow-up steps of one of the two conditions are as follows:

Step S504: the first indication flag shows that the transmission connection has been enabled; and

Step S505: the access status unit of the system uploads the file “M” to the data source via the data source access unit.

The follow-up steps of the other of the two conditions are as follows:

Step S506: the first indication flag shows that the transmission connection has yet to be enabled;

Step S507: the access status unit of the system modifies the third indication flag as “Need to enable the transmission connection”;

Step S508: the data source actively checks the third indication flag of the usage status data from the access status unit of the system;

Step S509: after the data source knows it is necessary to enable the transmission connection, the data source actively enables the transmission connection with the data source access unit; and

Step S510: the access status unit uploads the file “M” to the data source via the data source access unit of the system.

The step is for the client device to upload a file to the data source via the system according to the cloud data storage method of the present invention. If the data source has yet to receive the access request within a predetermined time period after the data source enables the transmission connection, the data source disables the transmission connection.

It will be apparent to those skilled in the art that various modifications and variations can be made to the disclosed embodiments. It is intended that the specification and examples be considered as exemplary only, with a true scope of the invention being indicated by the following claims and their equivalents.

According to the above exemplary embodiments and system structure, the present invention provides a data storage system and method which will not occupy the resources of the system, and the storage device will actively make a request to connect to the system.

The present invention further provides a system and method which can avoid additional cost because users do not need to purchase physical storage devices.

The present invention also provides a system and method which will notify the client device that the physical storage device is in connection status and usable again after the physical storage device is temporarily disconnected or shut down, and support the transmission resuming function.

In summation of the description above, the present invention can provide unpredictable technical effects which the prior art cannot provide, so completely conforms to the novelty and the obviousness regulated by Patent Act. Thus, Applicant files the invention application according to Patent Act; please grant the patent right of the invention application to encourage inventions and creations.

What is claimed is:

1. A cloud data storage system, comprising:
a data source access unit, connecting to a data source disposed outside, and the data source configured to store a digital content;
a client device access unit, connected to a client device for the client device to access the digital content from the data source access unit via the data source access unit; and
an access status unit, connecting to the data source access unit and the client device access unit, and acquiring a status of the data source and a status of the client device from the data source access unit and the client device access unit in order to generate or update a usage status data, wherein the access status unit determines whether the data source access unit connects to the data source, and whether the client device accesses the digital content via the data source access unit according to the usage status data.

2. The cloud data storage system of claim 1, wherein the usage status data stores a first indication flag, a second indication flag and a third indication flag; the first indication flag records whether a transmission connection between the data source access unit and the data source is enabled, the second indication flag records the digital content which the client device requests to access from the data source, and the third indication flag records whether the transmission connection between the data source access unit and the data source should be enabled.

3. The cloud data storage system of claim 2, wherein the usage status data are checked by the data source; when the status of the third indication flag shows the transmission connection should be enabled after checked by the data source, the data source access unit enables the transmission connection with the data source.

4. The cloud data storage system of claim 3, wherein the access status unit transmits the digital content to the client device via the client device access unit; when a transmission connection between the client device access unit and the client device has yet to be enabled, the access status unit transmits a file reception notification to the client device.

5. The cloud data storage system of claim 2, wherein when the transmission connection between the data source access unit and the data source lasts for a predetermined time period but the data source has yet to receive an access request, the data source access unit disables the transmission connection with the data source.

6. The cloud data storage system of claim 3, wherein when the transmission connection between the data source access unit and the data source lasts for a predetermined time period but the data source has yet to receive an access request, the data source access unit disables the transmission connection with the data source.

7. The cloud data storage system of claim 4, wherein when the transmission connection between the data source access unit and the data source lasts for a predetermined time period but the data source has yet to receive an access request, the data source access unit disables the transmission connection with the data source.

8. A cloud data storage method, comprising following steps:
connecting to a data source disposed outside by a data source access unit;
connecting to a client device disposed outside by a client device access unit;
acquiring a status of the data source and a status of the client device from the data source access unit and the client device access unit by an access status unit in order to generate a usage status data;
determining whether the data source access unit connects to the data source by the access status unit according to the usage status data; and
determining whether the client device accesses a digital content via the data source access unit by the access status unit according to the usage status data.

9. The cloud data storage method of claim 8, wherein the usage status data stores a first indication flag, a second indication flag and a third indication flag; the first indication flag records whether a transmission connection between the data source access unit and the data source is enabled, the second indication flag records the digital content which the client device requests to access from the data source, and the third indication flag records whether the transmission connection between the data source access unit and the data source should be enabled.

10. The cloud data storage method of claim 9, wherein the usage status data are checked by the data source; when the status of the third indication flag shows the transmission connection should be enabled after checked by the data source, the data source access unit enables the transmission connection with the data source.

11. The cloud data storage method of claim 10, wherein the access status unit transmits the digital content to the client device via the client device access unit; when a transmission connection between the client device access unit and the client device has yet to be enabled, the access status unit transmits a file reception notification to the client device.

12. The cloud data storage method of claim 9, wherein when the transmission connection between data source access unit and the data source lasts for a predetermined time period but the data source has yet to receive an access request, the data source access unit disables the transmission connection with the data source.

13. The cloud data storage method of claim 10, wherein when the transmission connection between data source access unit and the data source lasts for a predetermined time period but the data source has yet to receive an access request, the data source access unit disables the transmission connection with the data source.

14. The cloud data storage method of claim 11, wherein when the transmission connection between data source access unit and the data source lasts for a predetermined time period but the data source has yet to receive an access request, the data source access unit disables the transmission connection with the data source.
